(19) United States
(12) Patent Application Publication
(10) Pub. No.: US 2006/0206377 A1
(43) Pub. Date: Sep. 14, 2006

(54) METHOD OF REDEEMING A VALUE BEARING INSTRUMENT

(76) Inventors: Doug Huber, Louisville, KY (US); Thomas E. Soukup, Las Vegas, NV (US); Jeffrey George, Las Vegas, NV (US); Steve Southerland, Henderson, NV (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/276,313

(22) Filed: Feb. 23, 2006

Related U.S. Application Data
(60) Provisional application No. 60/659,623, filed on Mar. 8, 2005.
(60) Provisional application No. 60/659,624, filed on Mar. 8, 2005.

(51) Int. Cl. G07G 1/14

(52) U.S. Cl. 705/14

(57) ABSTRACT

The subject invention provides a method for redeeming a value-bearing instrument, such as a cash ticket issued from a slot machine, at any of a plurality of participating organizations, such as a casino. The organizations are remotely located from each other and associated together. Each of the organizations includes a computer, networked to a centralized host. The centralized host stores identifying information related to each instrument issued by the organizations. The instruments include identifying information associated therewith. A user presents the instruments to one of the organizations, which scans the two-dimensional bar code to read the identifying information stored therein. The organization connects to the centralized host through a secured Virtual Private Network to authenticate the instrument. If the instrument is validated, the organization issues cash to the user in an amount equivalent to a cash value of the instrument.

### CROSS REFERENCE TO RELATED APPLICATION

This application claims the benefit of Application Ser. Nos. 60/659,623 filed on Mar. 8, 2005 and 60/659,624 filed on Mar. 8, 2005, the advantages and disclosure of which are hereby incorporated by reference.

### BACKGROUND OF THE INVENTION

1. Field of the Invention

The subject invention generally relates to a method of redeeming a value-bearing instrument, and more specifically to a system and a method for redeeming a value-bearing instrument issued by one of a plurality of organizations remotely located from each other and associated together.

2. Description of the Related Art

Casinos and other gaming establishments often issue value-bearing instrument, such as a cash ticket, to users who win a game on a gaming machine, such as coin-less slot machines. A casino, after issuing the cash ticket, will exchange the cash ticket for money at pre-designated sites located throughout the casino. U.S. Pat. No. 6,843,418 (the '418 patent), issued to Jones et al., discloses a system and method for redeeming such a cash ticket.

The '418 patent includes a ticket acceptor for accepting the value-bearing instrument. The instrument includes a two-dimensional bar code printed thereon, which includes information related to a cash value of the instrument and an origin of the instrument. The gaming machine issues the instrument from within a facility, typically the gaming establishment. The gaming machines are often a coin-less redemption slot machine, and issue the instrument in lieu of currency or tokens in response to the user winning the game. A computer network connects the gaming machines located within the facility and communicates information regarding the issued instruments between the gaming machines, the computer network, and other devices located within the facility connected thereto at the time of issuance. The user redeems the instrument by placing the instrument into the ticket acceptor. The ticket acceptor scans the two-dimensional bar code with a bar code scanner to read the information included in the two dimensional bar code. The ticket acceptor compares the information read from the instrument with the information stored in the computer network to validate the instrument. Once the ticket acceptor has validated the instrument, the ticket acceptor issues the user cash in an amount equivalent to the value of the instrument.

The user is therefore able to play multiple gaming machines located within the gaming establishment or facility, collecting several different instruments therefrom, and then exchange the instruments for cash at a any location located within the gaming establishment. However, the user is unable to exchange the instruments for currency at any other location remotely located from the specific gaming establishment that issued the instrument. Accordingly, the user must redeem any instruments from the same gaining establishment that issued the instruments. This burdens the user with having to either redeem each instrument before leaving the gaming establishment, or returning later to do so. This is inefficient for the user and discourages the user from traveling between different gaming establishments. The present invention is aimed at solving one or more of the problems identified above.

### SUMMARY OF THE INVENTION AND ADVANTAGES

The subject invention provides a system and a method for redeeming one of a plurality of value-bearing instruments issued by one of a plurality of organizations. The system includes a plurality of organizations remotely located from each other and each having a gaming machine for issuing one of the plurality of instruments. A centralized host is accessible by each of the plurality of organizations and remotely located from at least one of the plurality of organizations. A plurality of remote devices is located at the plurality of organizations with at least one of the plurality of remote devices located at each of the plurality of organizations. A network interconnects the centralized host and the plurality of remote devices for transmitting data therebetween to verify identifying information associated with the one instrument to permit redemption of the one instrument at any of the plurality of organizations. The method includes the steps of: providing the centralized host accessible by each of the plurality of organizations and remotely located from at least one of the plurality of organizations; associating the identifying information with the one instrument; reading the identifying information associated with the one instrument to authenticate the one instrument; and connecting to the centralized host via the internet from one of the plurality of organizations to verify the identifying information associated with the one instrument to permit redemption of the one instrument at any of the plurality of organizations.

Accordingly, a user may play a variety of different gaming machines at several different organizations. The organizations are typically gaming establishments such as casinos, which have associated together to provide a more efficient and pleasant experience to the user. The user may thereby collect several different value-bearing instruments, such as cash tickets issued from a gaming machine, such as a slot machine, located at several different organizations. The subject invention permits the user to redeem any of the instruments at any of the organizations, thereby eliminating the problem of the user having to redeem each instrument at the individual organization that issued that specific instrument.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic diagram showing a system for redeeming a value-bearing instrument;

FIG. 2 is a schematic diagram of the system showing a remote device located at an organization;

FIG. 3 is a plan view of a value bearing instrument having a bar code disposed thereon;

FIG. 4 is a flow chart representing the steps of a method for redeeming the value bearing instrument; and

FIG. 5 is a flow chart representing the steps of an alternative embodiment of the method.

### DETAILED DESCRIPTION OF THE INVENTION

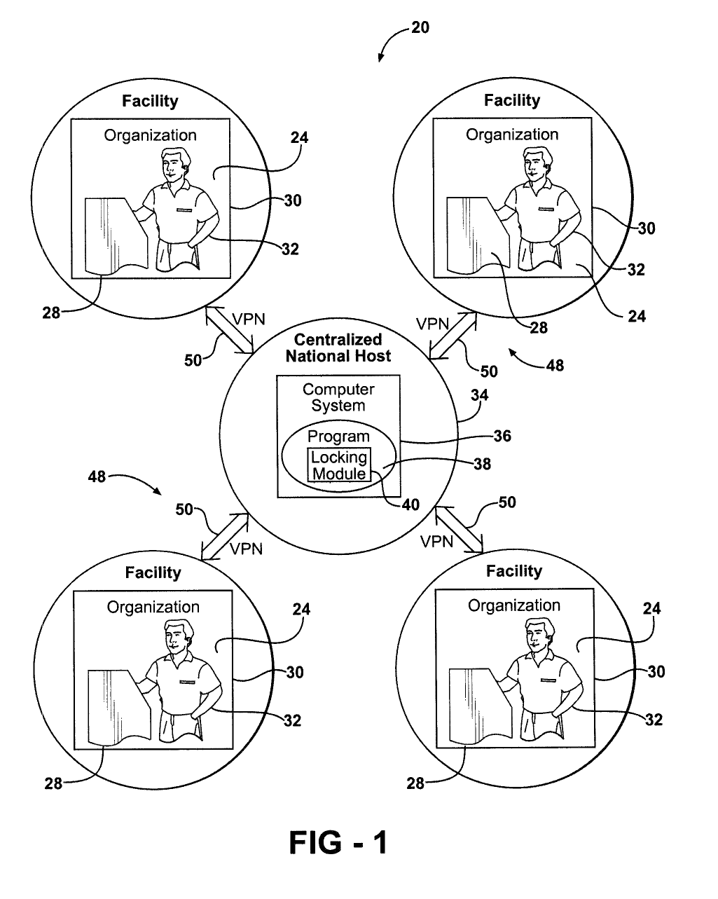

Referring to the Figures, wherein like numerals indicate corresponding parts throughout the several views, a system for redeeming a value bearing instrument 22 is generally shown at 20 in FIG. 1.

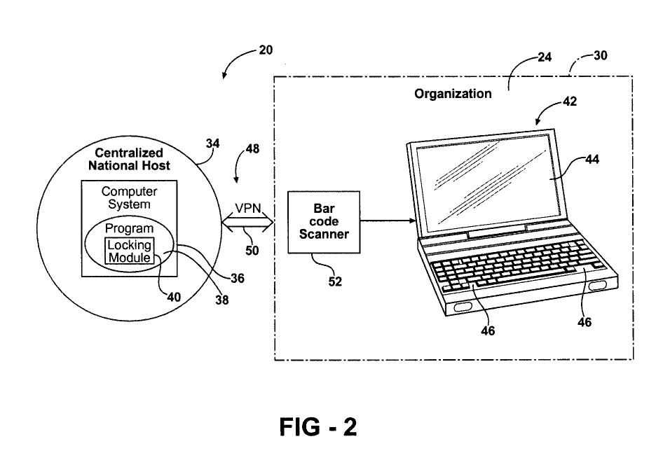

Referring to FIGS. 1 and 2, the system 20 includes a plurality of organizations 24, each located at a different facility. The organizations 24 are remotely located from each other, and each organization 24 includes at least one gaming machine 28 for issuing the instrument 22. The organizations 24 preferably include at least one gaming establishment 30, such as a casino, but may include any organization or business that wishes to participate as a member of the plurality of organizations 24. The organizations 24 are typically independently owned and operated, but it should be understood that some of the organizations 24 may be owned and operated (yet located at different facilities) by a single parent company. Typically, the gaming machine 28 will be a slot machine or a video slot machine, which issues the instrument 22 in lieu of cash in response to a user 32 winning a game at the gaming machine 28. However, it should be understood that the gaming machine 28 could be any device that issues the instrument 22 to the user 32. The instrument 22 is typically a cash ticket 26, but may also be a promotional item. Alternatively, the user 32 may purchase the instrument 22 from any of the organizations 24.

The system 20 further includes a centralized host 34. In one embodiment, the centralized host 34 stores identifying information related to the instrument 22. The centralized host 34 is typically located separately from each of the organizations 24, but it is also contemplated that the centralized host 34 may be located within the same facility as one of the organizations 24, and may even be owned and operated by one of the organizations 24. Alternatively, the centralized host 34 may be operated by another entity, such as the manufacturer or supplier of the system 20. The centralized host 34 includes a computer system 36 having a program 38 operable thereon, and is connected to a database (not shown) for storing the identifying information related to the instrument 22. The program 38 manages an account associated with each of the organizations 24, and includes a locking module 40 for indicating that the instrument 22 has previously been redeemed, thereby preventing more than one redemption of the instrument 22 at any of the organizations 24. The locking module 40 is implemented in and preferably part of the program 38.

A plurality of remote devices 42 is located at the plurality of organizations 24 for remotely operating the program 38 from each of the organizations 24. At least one of the remote devices 42 is located at each of the organizations 24. Each of the remote devices 42 may be implemented as a computer terminal, a personal computer, a laptop computer, a notebook computer, or some other suitable device. The remote device 42 includes an output interface 44 to deliver information to the user 32 and an input interface 46 for the user 32 to input commands or selections. The output interface 44 will typically include a monitor, or some other suitable device. The input interface 46 may include a keyboard, keypad, mouse, touch-screen, or some other suitable device.

A network, generally shown at 48, interconnects the computer system 36 of the centralized host 34 and the remote devices 42 for transmitting data therebetween. The data relates to the instrument 22 and includes identifying information such as a cash value of the instrument 22, the specific organization 24 that issued the instrument 22, and/or the specific gaming machine 28 that issued the instrument 22. It should be understood that other information may be transmitted between the remote device 42 and the centralized host 34 as well. The transmission of the data between the organizations 24 and the centralized host 34 permits validation of the instrument 22 and authorizes redemption of the instrument 22 at any of the plurality of organizations 24. The network 48 transmits data by either a hard-wired connection, a wireless connection, or a combination of hard-wired and wireless connections. Examples of networks 48 with hard-wired connections include, but are not limited to, the plain-old telephone service (POTS), fiber-optic communications, and Ethernet communications. Examples of networks 48 with wireless connections include, but are not limited to cellular telephone networks, personal communication system (PCS) networks, Wi-Fi networks, or Bluetooth. In one embodiment, the network 48 may be a Virtual Private Network (VPN) 50, which operates through the internet to connect the centralized host 34 to the remote device 42. The VPN 50 is secured, and only accessible by the organizations 24 and the centralized host 34, thereby preventing theft of the identifying information transmitted therebetween, and fraud against the system 20.

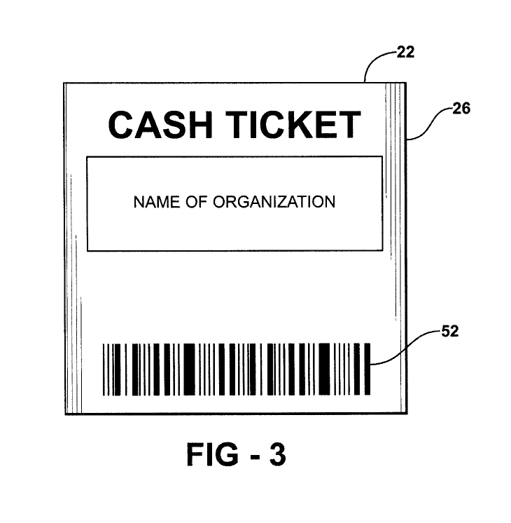

Referring to FIG. 3, the instrument 22 may include a multi-dimensional bar code 52 printed thereon. The multi-dimensional bar code 52 operates in a manner well known to those skilled in the art, and stores information related to the instrument 22 for identifying and validating the instrument 22. The multi-dimensional bar code 52 is preferably a two-dimensional bar code, but may also be a three-dimensional bar code. The system 20 further includes a bar code scanner 54 coupled to each of the plurality of remote devices 42 at each of the organizations 24. The bar code scanner 54 reads the identifying information stored in the multi-dimensional bar code 52 related to the instrument 22 and transmits the information to the remote device 42 attached thereto. The information may then be transmitted to the centralized host 34 via the VPN 50 operating through the internet to validate the instrument 22.

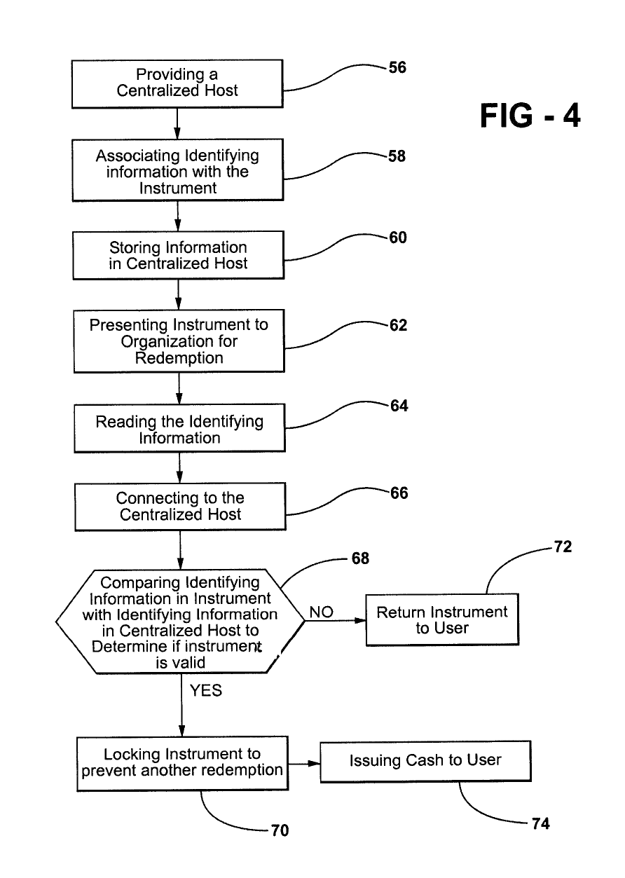

Referring to FIG. 4, the subject invention also provides a method of redeeming one of the plurality of value-bearing instruments 22 issued by one of the plurality of organizations 24 remotely located from each other and associated together. The method includes a first step 56 of providing the centralized host 34 accessible by each of the organizations 24 and remotely located from at least one of the organizations 24; and providing the program 38 operable on the computer system 36 of the centralized host 34 for managing the account associated with each of the organizations 24. The program 38 includes an interface (not shown) activatable by each of the organizations 24 to activate the program 38 on the centralized host 34 remotely from each of the organizations 24. The program 38 includes a report summarizing all of the outstanding instruments 22 issued by each of the individual organizations 24. Alternatively, the program 38 may include a report summarizing all of the instruments 22 redeemed by each of the individual organizations 24 and issued by another of the organizations 24. It should be understood that the program 38 may also include other reports summarizing other information that would be of interest to the centralized host 34 or any of the organizations 24.

The method further includes a second step 58 of associating the identifying information with the instrument 22, and reading the identifying information associated with the instrument 22 to authenticate the instrument 22. The identifying information associated with the instrument 22 is stored in the multi-dimensional bar code 52 disposed on the instrument 22. The identifying information stored in the multi-dimensional bar code 52 preferably relates to the cash value of the instrument 22, the individual organization 24 that issued the instrument 22. However, it should be understood that other information related to the instrument 22 may be stored in the multi-dimensional bar code 52 as well.

In a third step 60, the identifying information associated with the instrument 22 is stored in the centralized host 34. The information stored in the centralized host 34 preferably relates to the cash value of the instrument 22, or the individual organization 24 that issued the instrument 22. However, it should be understood that other information related to the instrument 22 may be stored on the centralized host 34 as well.

The method further includes a fourth step 62 of presenting the instrument 22 to any of the organizations 24 participating in the association of organizations 24 for redemption of the instrument 22. A fifth step 64 includes reading the multi-dimensional bar code 52 disposed on the instrument 22 by scanning the multi-dimensional bar code 52 with a bar code scanner 54 to read the identifying information stored therein. A sixth step 66 includes connecting to the centralized host 34 via the secured VPN 50 through the internet from one of the remotely located organizations 24 to permit redemption of the instrument 22 at any of the organizations 24. The information read from the multi-dimensional bar code 52 disposed on the instrument 22 is transmitted to the centralized host 34 via the VPN 50 through the internet to validate the instrument 22.

A seventh step 68 includes comparing the identifying information stored in the multi-dimensional bar code 52 disposed on the instrument 22 to the identifying information stored on the computer system 36 of the centralized host 34. The identifying information relates to the instrument 22 and is compared to validate the instrument 22. The identifying information stored in the multi-dimensional bar code 52 disposed on the instrument 22 must correspond to the identifying information stored in the computer system 36 of the centralized host 34 in order for the program 38 to validate the instrument 22.

If the instrument 22 is validated, the program 38 includes an eighth step 70 of locking the information stored at the centralized host 34 relating to the instrument 22 to prevent a second redemption of the instrument 22 at another of the organizations 24. The centralized host 34 then sends a message through the VPN 50 to at least one of the remote devices 42. The message indicates that the instrument 22 was validated and authorizes the organization 24 to issue cash in an amount equivalent to the cash value of the instrument 22 to the user 32 in exchange for the instrument 22.

If the identifying information stored in the multi-dimensional bar code 52 disposed on the instrument 22 does not correspond to the identifying information stored on the computer system 36 of the centralized host 34, the instrument 22 is not validated. In this situation, in a ninth step 72, the centralized host 34 then sends a message through the VPN 50 to the remote device 42. The message indicates that the instrument 22 was not validated, and the organization 24 should not redeem the instrument 22 and return the instrument 22 to the user 32.

A tenth step 74 includes issuing cash to the user 32 (holder of the instrument 22) in an amount equivalent to the cash value of the instrument 22. Accordingly, the user 32 may travel between multiple organizations 24 (casinos), each located at a different facility, and collect multiple instruments 22 (cash tickets) from the different organizations 24 over an extender period of time. The user 32 may then “cash-out” at the end of the extended period of time at any of the organizations 24 participating in the group of organizations 24.

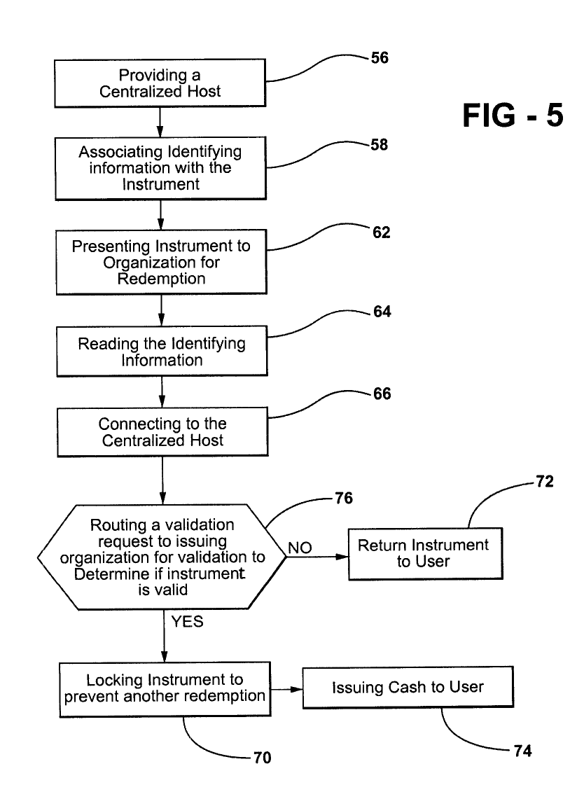

In an alternative embodiment having an eleventh step 76, it is contemplated that the organization 24 redeeming the instrument 22 (redeeming organization 24) will route a validation request through the centralized host 34 via the internet to the organization 24 that issued the instrument 22 (issuing organization 24). Referring to FIG. 5, the issuing organization 24 validates the instrument 22 based on the identifying information stored on the instrument 22 and routed along with the validation request to the issuing organization 24. The issuing organization 24 then routes a reply message through the centralized host 34 via the internet to the redeeming organization 24. The reply message would indicate that the instrument 22 is valid and the redeeming organization 24 should issue cash in an amount equivalent to the cash value of the instrument 22 to the user 32 in exchange for the instrument 22, or that the instrument 22 is not valid and the redeeming organization 24 should not issue cash in exchange for the instrument 22. Accordingly, it would not be necessary to store the identifying information on the centralized host 34 related to the plurality of instruments 22 issued by the plurality of organizations 24.

The foregoing invention has been described in accordance with the relevant legal standards; thus, the description is exemplary rather than limiting in nature. Variations and modifications to the disclosed embodiments may become apparent to those skilled in the art and do come within the scope of the invention. Accordingly, the scope of legal protection afforded this invention can only be determined by studying the following claims.

What is claimed is:

1. A method of redeeming one of a plurality of value-bearing instruments issued by one of a plurality of organizations remotely located from each other and associated together, said method comprising the steps of:
providing a centralized host accessible by each of the plurality of organizations and remotely located from at least one of the plurality of organizations;
associating identifying information with the one instrument;
reading the identifying information associated with the one instrument to authenticate the one instrument; and
connecting to the centralized host via the internet from one of the remotely located plurality of organizations to verify the identifying information associated with the one instrument and to permit redemption of the one instrument at any of the plurality of organizations.

2. A method as set forth in claim 1 wherein said step of connecting to the centralized host via the internet is further defined as connecting to the centralized host via a Virtual Private Network through the internet.

3. A method as set forth in claim 2 further comprising the step of locking the one instrument to prevent a second redemption of the one instrument at another of the plurality of organizations.

4. A method as set forth in claim 3 wherein said step of associating identifying information with the one instrument is further defined as storing the identifying information related to the one instrument in a multi-dimensional bar code disposed on the one instrument.

5. A method as set forth in claim 4 wherein the multi-dimensional bar code is defined as a two-dimensional bar code.

6. A method as set forth in claim 4 wherein the multi-dimensional bar code is defined as a three-dimensional bar code.

7. A method as set forth in claim 4 wherein the identifying information stored in the multi-dimensional bar code relates to a cash value of the one instrument.

8. A method as set forth in claim 4 wherein the identifying information stored in the multi-dimensional bar code relates to the one of the plurality of organizations that issued the one instrument.

9. A method as set forth in claim 4 further comprising the step of storing the identifying information in the centralized host related to each of the plurality of instruments issued by the plurality of organizations.

10. A method as set forth in claim 9 wherein the identifying information stored in the centralized host relates to a cash value of the one instrument.

11. A method as set forth in claim 9 wherein the identifying information stored in the centralized host relates to the one of the plurality of organizations that issued the one instrument.

12. A method as set forth in claim 90 further comprising the step of comparing the identifying information associated with the one instrument to the identifying information stored in the centralized host related to the one instrument to validate the one instrument.

13. A method as set forth in claim 1 further comprising the step of routing a validation request through the centralized host via the internet to the one of the plurality of organizations that issued the one instrument to validate the one instrument based on the identifying information associated with the one instrument.

14. A method as set forth in claim 4 further comprising the step of presenting the one instrument to any of the plurality of organizations for redemption.

15. A method as set forth in claim 14 further comprising the step of transmitting the identifying information read from the one instrument to the centralized host via the internet to validate the one instrument.

16. A method as set forth in claim 15 further comprising the step of issuing cash to the user in an amount equivalent to a cash value of the one instrument.

17. A method as set forth in claim 16 wherein the centralized host includes a computer system.

18. A method as set forth in claim 17 further comprising the step of providing a program operable on the computer system for managing an account associated with each of the plurality of organizations.

19. A method as set forth in claim 18 further comprising the step of displaying a report to summarize all of the outstanding plurality of instruments issued by the one of the plurality of organizations.

20. A method as set forth in claim 18 further comprising the step of displaying a report to summarize all of the plurality of instruments redeemed by the one of the plurality of organizations and issued by another of the plurality of organizations.

21. A method as set forth in claim 20 wherein the plurality of organizations includes a gaming establishment and the one of the plurality of value-bearing instruments includes a cash ticket issued from a gaming machine located at the gaming establishment.

22. A method of redeeming one of a plurality of cash tickets issued from a gaming machine by any of a plurality of gaming establishments remotely located from each other and associated together, said method comprising the steps of:
providing a centralized host accessible by each of the plurality of gaming establishments and remotely located from at least one of the plurality of gaming establishments;
associating identifying information with the one cash ticket;
reading the identifying information associated with the one cash ticket to authenticate the one cash ticket; and
connecting to the centralized host via the internet from one of the remotely located plurality of gaming establishments to verify the identifying information associated with the one cash ticket and to permit redemption of the one cash ticket at any of the plurality of gaming establishments.

23. A method as set forth in claim 26 wherein said step of connecting to the centralized host via the internet is further defined as connecting to the centralized host via a Virtual Private Network through the internet.

24. A method as set forth in claim 23 further comprising the step of locking the one cash ticket to prevent a second redemption of the one cash ticket at another of the plurality of casinos.

25. A method as set forth in claim 24 wherein said step of associating identifying information with the one cash ticket is further defined as storing the identifying information related to the one cash ticket in a multi-dimensional bar code disposed on the one cash ticket.

26. A method as set forth in claim 25 wherein said multi-dimensional bar code is further defined as a two dimensional bar code.

27. A method as set forth in claim 25 wherein said multi-dimensional bar code is further defined as a three dimensional bar code.

28. A method as set forth in claim 25 wherein the identifying information stored in the multi-dimensional bar code relates to a cash value of the one cash ticket.

29. A method as set forth in claim 25 wherein the identifying information stored in the multi-dimensional bar code relates to the one casino of the plurality of casinos that issued the one cash ticket.

30. A method as set forth in claim 25 further comprising the step of storing the identifying information in the centralized host related to each of the plurality of cash tickets issued by any of the plurality of gaming establishments.

31. A method as set forth in claim 30 wherein the identifying information stored in the centralized host relates to a cash value of the one cash ticket.

32. A method as set forth in claim 30 wherein the identifying information stored in the centralized host relates to the one casino of the plurality of casinos that issued the one cash ticket.

33. A method as set forth in claim 30 further comprising the step of comparing the identifying information stored on the one cash ticket to the identifying information stored in the centralized host related to the one cash ticket to validate the one cash ticket.

34. A method as set forth in claim 25 further comprising the step of routing a validation request through the centralized host via the internet to the one of the plurality of gaming establishments that issued the one cash ticket to validate the one cash ticket based on the identifying information stored in the one cash ticket.

35. A method as set forth in claim 25 further comprising the step of presenting the one cash ticket to any of the plurality of gaming establishments for redemption.

36. A method as set forth in claim 35 further comprising the step of transmitting the identifying information read from the one cash ticket to the centralized host via the Virtual Private Network over the internet to validate the one cash ticket.

37. A method as set forth in claim 36 further comprising the step of issuing cash to the user in an amount equivalent to a cash value of the one cash ticket.

38. A system for redeeming one of a plurality of value bearing instruments, said system comprising:
a plurality of organizations remotely located from each other and each having a gaming machine for issuing one of said plurality of instruments;
a centralized host accessible by each of the plurality of organizations and remotely located form at least on of the plurality of organizations;
a plurality of remote devices located at said plurality of organizations with at least one of said plurality of remote devices located at each of said plurality of organizations; and
a network interconnecting said centralized host and said plurality of remote devices for transmitting data therebetween to verify identifying information associated with said one instrument to permit redemption of said one instrument at any of said plurality of organizations.

39. A system as set forth in claim 38 wherein said network includes a Virtual Private Network operated through the internet.

40. A system as set forth in claim 39 wherein said centralized host includes a computer system having a program operable thereon for managing an account associated with each of said plurality of organizations.

41. A system as set forth in claim 40 wherein said one instrument includes a multi-dimensional bar code for storing the identifying information therein related to said one instrument.

42. A system as set forth in claim 41 further comprising a bar code scanner for reading the identifying information stored in said multi-dimensional bar code.

43. A system as set forth in claim 42 wherein said program includes a locking module for securing the identifying information stored on said computer system related to said one instrument to indicate redemption of said one instrument and preventing more than one redemption of said one instrument at any of said plurality of organizations.

44. A system as set forth in claim 43 wherein said one instrument includes a cash ticket.

45. A system as set forth in claim 44 wherein said plurality of organizations includes a gaming establishment.
